(19) United States
(12) Patent Application Publication
(10) Pub. No.: US 2013/0230831 A1
(43) Pub. Date: Sep. 5, 2013

(54) System and Method of Integrating Environmental Awareness into Classroom Lesson Plans

(71) Applicant: Sapna Sopori, Bainbridge, WA (US)

(72) Inventor: Sapna Sopori, Bainbridge, WA (US)

(21) Appl. No.: 13/745,708

(22) Filed: Jan. 18, 2013

Related U.S. Application Data
(60) Provisional application No. 61/587,906, filed on Jan. 18, 2012.
(60) Provisional application No. 61/600,129, filed on Feb. 17, 2012.

(51) Int. Cl. G09B 19/00

(52) U.S. Cl. CPC G09B 19/00
USPC 434/219

(57) ABSTRACT

A method of training educators to develop environmentally aware lesson plans using a computer-implemented professional development system is provided. The method integrates awareness of environmental issues into general-studies teaching and includes a computer having a data base housing a plurality of environmental-specific instructional materials and materials relating to human behavior and development. The method comprises the steps of: assembling one or more educators; providing access to a computer device to each educator; providing a server connected to the computer device wherein the server includes a data base housing foundational tools and information concerning culture's influence on environmental awareness; in one or more training sessions and by accessing the data base, training the educators about environmental awareness; and instructing the educators to develop at least one environmentally aware lesson plan utilizing the training.

### CROSS-REFERENCE TO RELATED APPLICATIONS

This application claims the benefit of U.S. patent application Ser. No. 61/587,906, filed Jan. 18, 2012 and U.S. patent application Ser. No. 61/600,129, filed Feb. 17, 2012.

### TECHNICAL FIELD

This invention generally relates to computer-implemented systems and methods for professional development for teachers/educators so that these teachers/educators produce quality lesson plans, and more particularly, to systems and methods for providing a structured framework for training teachers using computer-based resources on how to integrate awareness of current environmental issues and concerns into non-advocacy, developmentally appropriate, culturally aware and standards-aligned lesson plans for the teaching of general curriculum subjects.

### BACKGROUND

Environmental issues, concerning clean water and air and preserving our natural resources for example, are plentiful and important. Many of these issues are not raised or discussed in the classroom or, if raised or discussed at all, are brought to the attention of students only through isolated studies in later grades. It has been found that the infusion of information about environmental issues into general classroom studies can meaningfully teach these issues to the students within the framework of their general studies. However, in today's classroom, with teachers being pressured to concentrate on the core subjects (math, science, social studies and English), these teachers are not well-prepared to develop lesson plans which provide such integrated studies touching upon environmental issues.

Instructional materials, including lesson plans, are an essential component to a well-taught curriculum. A well-planned lesson is much more likely to enrich students, ensure adequate coverage of the subject matter, and make a teacher's professional life a bit easier. Unfortunately, many teachers do not have the time or the training to prepare high quality instructional materials that would include environmental topics, or the training to teach the subject matter in an effective way. Further, many teachers may not have an understanding of how known human development traits of the students can be utilized to make learning of the issues more effective. Complete and comprehensive instructional materials that would take these factors into consideration and be used in the classroom in a consistent manner are perhaps the most essential tools when striving to provide the desired instruction. Thus, it is important that training is provided to the teachers so that teachers achieve these goals toward integrating environmental awareness into general classroom studies by developing high quality instructional materials, such as lesson plans.

### SUMMARY OF THE INVENTION

In an exemplary implementation of the invention, a professional development system and methodology for educators to produce quality lesson plans is provided. The system is divided into separate days of instruction, as an example, five days, which culminate in the generation of an environmentally aware lesson plan. In one aspect of the invention, a morning session of the instructional day is dedicated to teaching a portion of the method of integrating environmental awareness into general classroom studies, in accordance with the invention, while the afternoon session may be spent teaching the educators about various topics concerning the environment or the ecology of their local region. The system includes a computer system having a database and a plurality of subject-specific instructional materials. The professional development system and methodology may include one, some or all of the following modules:

Learning Day #1 topic: Foundation
Summary: This first learning day lays the foundation for the Awareness Together Program (“ATP”) through a better understanding of culture's influence on environmental awareness, how this relates to the history of environmental education and its future, and the role of personal ethics and advocacy in environmental education.
Technology used: Technology, Entertainment, Design (“TED”) video (on-line)
Objectives: Participants will:

understand that this program is designed to give a baseline understanding to all participating educators; each class will whet the intellectual appetite but it is the discussion and group dynamic that gives meaning and allows for growth during the program

question why we as a society believe what we believe in science and how that relates to the job of an environmental educator

discuss the various definitions of Environmental Education (EE) and create a personal and class definition

be introduced to over 100 years of legislation, policies, leaders, movements, etc. in EE, what we are working on today, and where it is headed for tomorrow

examine the spectrum of environmental ethics, looking at past foundational EE documents, and questioning personal ethics for how we individually choose to teach, how this works with the ethics of those around us, and what our goal is for the future

understand the distinction between advocacy and education and how each is used to further the environmental culture of America

Homework: read related subject matter material
Learning Day #2 topic: Human Development and EE: from pedagogy to andragogy
Summary: This learning day builds on the foundation through a better understanding of how humans develop and how that affects both learning and teaching of environmental education. Information and activities are based on education theories from Piaget, Vygotsky, Gardner, and more.
Technology used: PowerPoint, websites for learning styles tests
Objectives: Participants will:

understand how physical, socio-emotional, and cognitive development affects learning throughout human development and the role EE plays at each stage

be introduced to leaders in the field of human development

understand how learning styles and multiple intelligences can be addressed at all developmental stages and in various settings

discover how their own learning styles and multiple intelligences affect their teaching styles and subsequently their students' learning

take part in activities that address the needs of students at various developmental stages and how they can be adapted to meet others

Homework: read selections from different cultural education texts
Learning Day #3 topic: Multicultural EE
Summary: This learning day expands on human development by exploring human cultural lenses and their role in environmental education. Specific lenses addressed: gender, language, race/ethnicity, and socio-economics.
Technology used: PowerPoint, video clips
Objectives: Participants will:

be introduced to the concept of cultural lenses and the need for introspection to increase awareness

understand the concept of the dominant cannon in education, how it is perpetuated, and the levels of incorporation

examine 4 cultural lenses: race/ethnicity, social class, gender, and language

take part in activities that address the needs of students at various developmental stages and how they can be adapted to meet others

Homework: read selected portions of No Child Left Behind or other applicable state or federal educational acts or laws.
Learning Day #4 topic: American Public Schools and EE
Summary: This learning day combines the previous topics of development and culture to examine the history of education in America and how it has affected and will continue to affect environmental education.
Technology used: PowerPoint
Objectives: Participants will:

examine the roots and history of American public schools

discuss the many tasks the public schools have been assigned over time, from social equalizer to educating for national security

participate in small group discussions on current education topics: Teacher Unions, Native American Education in the West, Charter Schools, Standards and Testing, Special Education and Exceptionalities

discuss if, where, and how EE fits into the current state of public school education

take part in activities that address the needs of students at various developmental stages and how they can be adapted to meet others

Homework: align an existing lesson plan (from areas such as Project WET/Wild/Learning Tree, Game and Fish, American Association for Employment in Education (“AAEE”), etc.) to particular State Science Standards
Learning Day #5 topic: “Curriculum Development and EE Resources: Don't reinvent the wheel!”
Summary: This learning day uses the previous lessons and discussions to culminate in the development of a non-advocacy, developmentally-appropriate, culturally-aware, and standards-aligned lesson plan. Also encourages the adaptation of existing EE curriculum and resources to increase efficiency.
Technology used: PowerPoint
Objectives: Participants will:

learn how to develop an EE lesson plan and incorporate the theory learning from prior sessions into this planning, from child development to cultural lenses

discuss how to adapt existing lesson plans and personalize them to fit any educational setting and teaching style so as not to reinvent the wheel

learn how properly research and vet sources to ensure scientific credibility

take part in activities that address the needs of students at various developmental stages and how they can be adapted to meet others

Homework: create own lesson plan

### BRIEF DESCRIPTION OF THE DRAWINGS

The foregoing and other objects, aspects, and advantages will be better understood from the following detailed description of a preferred embodiment of the invention with reference to the drawings, in which:

FIG. 1 is a block diagram of an exemplary computing and network environment for implementing a system and methodology in accordance with the invention; and

FIG. 2 is a block diagram similar to FIG. 1 wherein a trainer/facilitator may access aspects of the system, in accordance with the invention.

Those skilled in the art will appreciate that the invention is not limited to the exemplary embodiments, configurations, components or sequence of steps shown in the figures.

### DETAILED DESCRIPTION

In an exemplary implementation, the system provides a structured framework and methodology for efficiently producing and providing complete and comprehensive instructional materials that have a consistent format; making the lessons plans and corresponding courses available to the educators for purposes of training educators on how to effectively integrate environmental awareness into general classroom studies.

Instructional materials may be in print, electronic or other form now known or hereafter developed. Additionally, instructional materials may employ conventional text, symbols, charts, tables, pictures, graphics, abbreviations, multimedia, codes or any other information, works of authorship and means of expression.

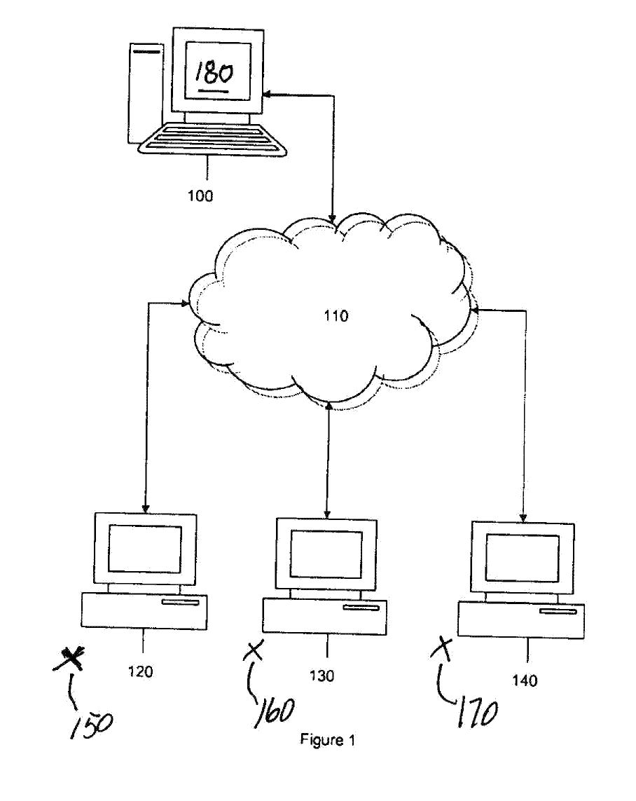

In an exemplary implementation, a networked computer system is employed to facilitate use by various participating educators. Referring to FIG. 1, an exemplary computing and network environment for implementing a system and methodology in accordance with principles of the invention is shown. Illustratively, a plurality of computing devices 120, 130 and 140, made accessible to a plurality of participating respective educators 150, 160, 170, are communicatively coupled to a server 100 via network communication means 110.

In the exemplary configuration, as shown in FIG. 1, each computing device 100 and 120-140 may, for example, be a conventional computer with a processing unit, a system memory and a system bus that communicatively couples various system components including the system memory to the processing unit. The exemplary system also includes one or more data bases 115 that include instructional materials.

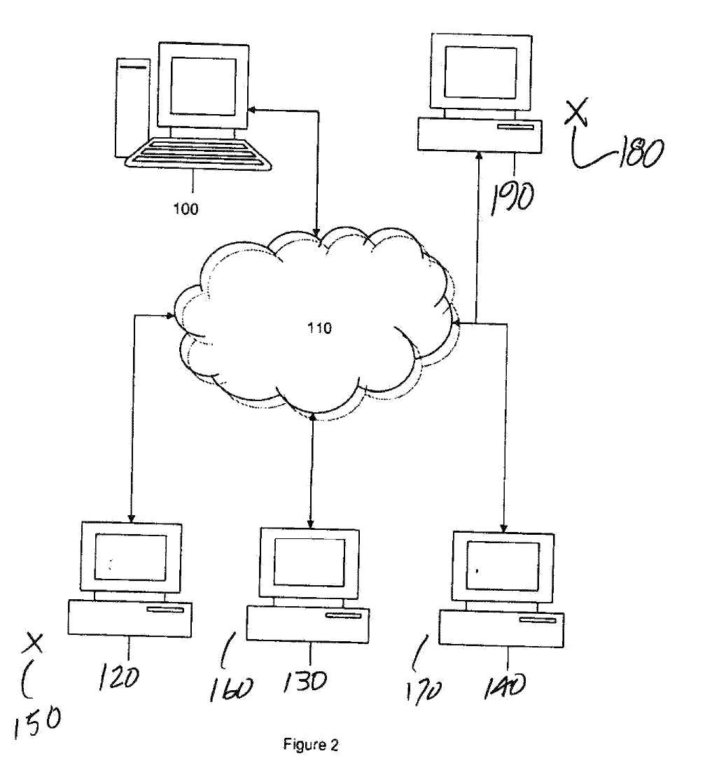

Referring now to FIG. 2, a trainer/facilitator 180 having access to computer device 190 is shown. Trainer/facilitator 180 is provided with super-user privileges and may access all aspects of the system, thereby enabling trainer/facilitator 180 to oversee the training sessions.

Specifically, learning day #1 of the system and method of integrating environmental awareness into general classroom studies may include:

### Introduction to EE Certification; Foundations of EE

### Learning Objectives:

understand that this program is designed to give a baseline understanding to all participating educators; each class will whet the intellectual appetite but it is the discussion and group dynamic that gives meaning and allows for growth during the program

learn the Who, What, When, Where, Why, and How of the EE Cert Program

question why we as a society believe what we believe in science and how that relates to the job of an environmental educator

discuss the various definitions of EE, how it differs from general science education and environmental interpretation, and create a personal and class definition

be introduced to over 100 years of legislation, policies, leaders, movements, etc. in EE, what we are working on today, and where it is headed for tomorrow

examine the spectrum of environmental ethics, looking at past foundational EE documents, and questioning personal ethics for how we individually choose to teach, how this works with the ethics of those around us, and what our goal is for the future

Materials: sign in sheet, name tags, copies of portfolio contents: binders (optional), region's particular Code of Ethics, North American Association for Environmental Education (“NAAEE”) Guidelines for Excellence (short and long list), Learning Day Evaluation/Assessment, Teaching Observation rubric, Overall Program Evaluation, and Portfolio Contents list; EE Timeline, Science and Cultural Beliefs worksheet, laptop/projector with internet access, EE definitions, Environmental Ethics quotes and worksheets
Introduction to EE Certification (8:30 am-10:30 am)

1. Welcome participants; have them fill out name tags and sign in.

2. Once group is assembled, introduce yourself and explain the outline and objectives for the day.

3. The morning portion will introduce the EE certification program and answer any questions they may have about the process, expectations, and portfolio development.

4. The Who, What, When, Where, Why, and How of EE Certification:
a. Who:
   i. introduce key members of your certification team
   ii. have each participant introduce themselves and their background or intended future in EE
   iii. do “get to know you” activity
b. What:
   i. this program is designed to give each participant a baseline understanding of EE and will help to professionalize the field
   ii. briefly review the history of EE certification in America and give an overview of the Environmental Literacy Plans happening in states across the country
   iii. introduce the AAEE and its role in this program
      1. Code of Ethics: have participants review the Code of Ethics, sign it, and keep it in their portfolios
c. When:
   i. confirm dates;
   ii. explain absence policy: only one allowed absence with approved excuse; if more than one absence, must go through individual certification; explain that each participant adds to the class and absences detract from group dynamic and learning
d. Where: field trips off-site; etc.
e. Why:
   i. Ask participants why they are in the program
   ii. we are united by the belief that we are never finished learning
   iii. this program will help all learners at all stages of their EE career
   iv. expand on group dynamic benefit
f. How:
   i. professional development for environmental educators requires:
      1. essential science content through perspective and methods of inquiry
      2. integrating knowledge of science, learning, pedagogy/andragogy, and students to science teaching
      3. building understanding and ability for lifelong learning and analysis
      4. coherent and integrated practices
   ii. state's particular EE Certification Program (where applicable) was designed to meet these goals through the following practices
   iii. Learning Days (LDs): 50 hours
      1. mornings will be spent learning more about environmental education theory through the Awareness Together Program, a learner-driven curriculum that is steeped in introspection and uses past experiences of the participants to increase group understanding
      2. afternoons will be spent learning about the natural history and ecology the particular region through hands-on field experiences
      3. NAAEE and Competencies:
         1. introduce the NAAEE and the Guidelines for Excellence: Professional Development for Environmental Educators
         2. have participants look through the Semester Agenda with Categories; explain that the topics and field experiences were chosen with a specific goal in mind: to meet the NAAEE competencies
         3. review the Full and Short Competencies handouts
         4. each LD will end with a review of which competencies were hit and how; participants will record these “hits” on the short list
         5. participants complete a LD Self-Assessment expanding on these “hits” and keep it in their portfolios
         6. participants will also complete a LD Program Evaluation
         7. review the LD Self-Assessment and Program Evaluation forms; a copy of each must be submitted to the program leader within 3 days of each LD
   iv. Readings: 10 hours
      1. each LD will have readings or homework to prepare participants; these are mandatory; review LD Topics and Homework handout
      2. upon request, program leader can supply additional resources and readings for further understanding
   v. Practicum: 20 hours
      1. 8 hours observing EE lessons taught in a formal setting (i.e.

public school classroom, community college class, etc.)
2. 4 hours observing EE lessons taught in the field for either formal or non-formal groups
3. 8 hours leading EE lessons; can be either formal or non-formal and in the field or in the classroom; curriculum can be made by the participant or adopted from another agency/organization; this requirement cannot be assessed by a participant in the class (must be assessed by an outside professional)
4. review Observer Rubric; each rubric needs to be submitted to program leader within 3 days of observation and a copy must be kept in participant portfolio
5. encourage diversity in observations (different types of classes, grade ranges, instructors, etc.)
vi. Curriculum Development: 10 hours
   1. each participant will need to develop their own lesson plan, which will be evaluated by small groups on the last LD because this will become a significant part of the portfolio, participants are recommended to follow the NAAEE Guidelines for Excellence: Materials
vii. Portfolios: 10 hours
   1. the portfolio is a collection demonstrating to the AAEE board how the NAAEE competencies were met by each participant during this program
   2. portfolios must contain the following: (refer to Portfolio Contents handout)
      1. cover page with title, participant name, certification organization, and submission date (ex. “Environmental Education Certification Portfolio for Jane Doe through the Willow Bend Environmental Education Center; submitted Jun. 7, 2011”)
      2. Participant Application, including essay and pre/post-program scaling questions
      3. signed Code of Ethics
      4. EE Core Competencies—expanded list
      5. LD dividers; each divider should include:

i. EE Core Competencies (short list) with “hits”

ii. LD Self-Assessment and Program Evaluation

iii. All readings (or, a bibliography)

iv. Completed homework assignments

v. All handouts and notes
6. Practicum Divider; should include:

i. All observation rubrics completed by participant

ii. All observation rubrics completed about participant

iii. Lesson Plan developed by participant

iv. Self-analysis paragraph (minimum 150 words) summarizing teaching component (8 hours)

5. Allow participants to ask any remaining questions about the process of EE certification

Break: 15 minutes
Science and Cultural Beliefs (10:45-12 noon)

1. explain that we will begin our first session with an exploration about science and cultural beliefs

2. hand out Science and Cultural Beliefs worksheet; split into small groups and allow 20 minutes for participants to answer questions; have computers available for research

3. discuss activity and group answers; have answer sheet ready for reference

4. play the clip http://www.ted.com/talks/jonathan_drori_on_what_we_think_we_know.html by Jonathon Drori. Discuss the clip and what it says about our current system of teaching.

5. How does this relate to EE? How does EE differ from general science education or interpretation? Discuss these questions and ask participants to think about their own definitions to create a group definition of EE at the end of class.

Break for lunch (12 noon-12:30)

### Defining EE (12:30-1:30)

1. ask participants to reflect on their own understanding of EE (refer to applications, if necessary).

2. hand out the EE definition quotes to small groups; have them discuss their quote and how they feel it addresses their concept of EE

3. regroup and have participants share their thoughts; have secretary track comments in order to create a group definition of EE at the end of the LD

4. briefly revisit the question “how is EE different from environmental interpretation?”;
a. explain that interpretation is often a one-time event without integration into personal/professional lives of participants.
b. EE is more integrated with a captive audience and is usually in a series or cohesive curriculum.
c. example: a set tour of a local park by a park ranger for families, adults, etc. is an interpretive event. That same ranger visiting a classroom of students multiple times with standards-aligned lesson plans that fit within the teacher's curriculum is EE.
d. interpretation is often seen as an introduction to EE and/or as the only realistic option in busy daily lives, especially for adults. Refer participants to the article Environmental Education and Environmental Interpretation: the Relationships by Douglas Knapp.

5. Ask participants if and how general science education differs from their understanding of EE.

6. revisit the quotes; explain they represent the perception of EE over time and will help us understand the roots of EE in America

### History of EE in America (1:30-2:15)

1. hand out one timeline card to each participant and have them work together to stand in order of their cards

2. after the line is made across the room, have each participant read off their card, starting with the oldest to most recent

3. regroup and go through each point on the timeline; have printed Timelines for reference; ask participants to discuss any trends or offshoot disciplines they notice:
a. began with nature study (learning in and from nature); moved to resource conservation; emphasis shifts to negative effects of human environmental actions on humans; questioning which humans are more affected by such changes (environmental justice); sustainability (essentially, resource conservation for the 21^{st} century); connections between student achievement and EE; new green economy
b. ask participants if there is anything they notice about the focus of each of these movements: everything in defined EE has been human-centered. Discuss the reasons why, who is left out as “second class” in this focus, is this due to realism or myopia, etc.
c. explain that each of these historic markers is rooted in specific ethics, or a set of principles or a system of right conduct and moral values
   Break: 15 minutes

### Environmental Ethics and Education (2:30-3:45)

1. Put environmental ethics quotes around the room. Have participants walk around and rate each quote using the table. Be sure to emphasize that this is a personal ethics activity, and participants should rate the quotes based on their own system of beliefs.

2. have participants break into small groups to discuss their ratings and impressions.
a. regroup and discuss the activity. Ask participants if they noticed a “spectrum” or natural categorization for the ethics of these quotes.
b. Discuss the following broad categories of environmental ethics and ask participants which quotes fit within each ethic.
c. For further information on these ethics, see Resources Cited.

3. Utilitarianism:
a. Often known as anthropocentrism, reform environmentalism, shallow ecology, conservationism, and resourcism
b. According to Max Oeschlaeger, author of The Idea of Wilderness, the basic premise of this ethic is that natural systems are no more than a collection of parts and the value of said parts is determined by the market (287).
c. This ethic endorses and is propelled by the notion that “the human species [is ] the most significant fact of existence” (293).
d. Philosopher Bill Devall believes that anthropocentrism is based on three key principles: “sustained economic growth is necessary to achieve higher environmental quality; government regulation benefits both economy and environment; and environmental groups must use the same strategies for the [future] as have been successful during the past two decades” (10).

e. This ethic has been the predominant one of the American environmental history for the past 150 years and has “saved thousands upon thousands of acres of wilderness and countless animals” (Gancher, 143).

4. Biophilia:
a. In 1984, E. O. Wilson published his book Biophilia, in which he explained and demonstrated the theory that humans are innately connected to nature. Biophilia, or the “innate tendency to focus on life” (1). Literally translated, biophilia is the affinity towards or love of life. Humans are a part of all life around them; all actions within the environment will fundamentally affect humans.
b. Moves beyond traditional utilitarianism towards a more “robust” framework, one that “supports significantly more environmental protection than does a defense in terms of material and commodity benefits alone” (Levy 2).
c. This ethic helps to spark a sense of stewardship in society while working within the existing framework (Wilson 140).

5. Deep Ecology:
a. Rooted in ecocentrism, which originated in America after World War II from the works of such transcendental authors as Aldo Leopold. Goes beyond viewing biodiversity as resources. Based on the belief that all living things merit regard and respect independently of their utility to humans (diZerega 2) and strives to reconnect humans with nature because we are “inescapably bound with natural process” (Oeschlaeger 295). Humans no longer lie at the center of all things nor do we culminate evolution (295).
b. Founded by Arne Naess in 1973, deep ecology moves even further by “developing a pervasive critique of advanced industrial culture” (Oeschlaeger 301) and it “seeks a reappraisal of many aspects of Western, science-based technological society” (O'Sullivan 92). Deep ecologists see humans as “knots in the biospheric net” and not just “skin-encapsulated egos” (Naess qutd. in O'Sullivan 92). Therefore, humans must take care of the earth, not for ourselves, but because it is our duty as part of the natural community (Oelschlaeger 301).
c. Deep ecologists strive to the process of “grounding ourselves through fuller experience of our connection to the earth” (Devall 11). The “deepness” of the movement is based on intuitive beliefs found by “exploring our dreams to recognize our archaic unity with all life” (Devall 11) to increase our ecological consciousness and become more “aware of the actuality of the rest of nature” (O'Sullivan 93).
d. Often, deep ecology is considered more of an intellectual movement or a collection of diverse ideas than a well-defined paradigm (Oelschlaeger 305), and seen as closer to a religion than a legitimate philosophy and more mystic than scientific (304).
e. sometimes seen as anti-human (304) and can take radical stands on population issues (even to suggest lowering the total human population to 100 million; O'Sullivan 96).
f. does not generally include “economic realities that underlie many of the environmental controversies” (Gancher 144) and seen as “hopeless utopianism” (Oelschlaeger 304).

6. What does it all mean?
a. It is very important to be familiar with different ethics because each of us is likely to work with or teach others with different ethics from our own. Each person forms their ethics based on their own life experiences. We must always remember that we are working towards a common goal and respect is an absolute requirement to effectively educate about the environment.
b. Discuss where advocacy lies within this spectrum. Is it a part of EE?
   i. Discuss AAEE's stance on advocacy vs. EE. EE is designed to reconnect people to the environment and create analytic thinkers that are able to critically assess any issue. Advocacy is active support of an idea or cause etc.; especially the act of pleading or arguing for something (http://www.thefreedictionary.com/advocacy). In EE, learners develop their own stances on topics without the educator influencing that with his/her personal opinions. This may seem like a subtle difference but it is one that encourages objectivity in the educator and allows for respectful discussions of complex issues.
   ii. Make the distinction clear that Action and Advocacy are not synonymous. A natural progression of EE is connection to empowerment to action. Environmental educators do not give yes or no answers on issues; instead we encourage assessment of all sides of the issue.
   iii. Ask participants to discuss the EE answer to the question “should I recycle?” An EE answer would be, “Based on what we have learned already, what do you think?” This allows for the learner to look at the pros and cons of recycling and opens up a discussion for the benefits of reduce and reuse before recycling.
   iv. It is very important to have a strong, unbiased, up-to-date science background for all EE lesson plans. Without this, issues can be clouded and personal offense may occur.
   v. Be sure to explain that advocacy is not bad. In fact, so much good has come from environmental advocates, and many educators may argue that it is an important part of EE. However, the AAEE has a strict non-advocacy policy and it is important to follow that guideline to ensure cooperation from all sides of an issue.
c. Revisit the EE timeline and reference the homework (Belgrade Charter, Tblisi Document, and Stapp article). Discuss the general ethic of EE so far. Where has it been and what is the potential for where can it go? Are there any parameters that might keep it from expanding beyond its current state? How does the federal government, education standards, economic realities for education centers and schools, etc. fit into this discussion?
d. Where does the group definition of EE fit on the ethics spectrum? Begin taking words or phrases from participants to create a group EE definition. Explain that this will be a work in progress and we will revisit it each LD for expansion/adjustment.
e. Ask participants to remember these discussion points because they lay the foundation for the remaining Learning Days this semester.
   Break: 15 minutes

### Summary (4:00-4:30)

1. Ask participants to briefly give their perceptions and opinions of today's topic and discussions. May want to limit amount of time per person.

2. Go through the competencies and record the “hits.”

3. Introduce the topic for the next LD and hand out the homework.

Specifically, learning day #2 of the system and method of integrating environmental awareness into general classroom studies may include:
Human Development: from pedagogy to androgogy

### Learning Objectives:

understand how physical, socio-emotional, and cognitive development affects learning throughout human development and the role EE plays at each stage

be introduced to leaders in the field of human development

understand how learning styles and multiple intelligences can be addressed at all developmental stages and in various settings

discover how their own learning styles and multiple intelligences affect their teaching styles and subsequently their students' learning

Materials: laptop/projector, PowerPoint handouts, Visual Auditory Kinesthetic (“VAK”) test copies, laptops and access to internet for Multiple Intelligences “(MI”) tests

I. Introduction: (8:30-11:00 am)
a. Welcome participants; pass out sign in sheet; review the agenda for the day
b. Review homework and discuss readings (Beyond Ecophobia by David Sobel); ask participants what they thought of the readings and how it relates to their personal experiences in education, either as a teacher or as a student. Explain that today we will delve into the science of human development to better understand ourselves, our students, and our roles as environmental educators.
c. As with every class in the ATP, group input and discussion is not only valued, it is critical. Our experiences as individuals and as educators will help open others' eyes to new perspectives. Shared thoughts help support the group. If comfortable, please share experiences and thoughts during all classes.
d. Pass out handouts; use notes in the power point.
e. Have a short 5-10 minute break after each age range discussed.

II. Conclusion: (11-11:30 am)
a. After the power point and activities, review with the participants and ask their opinions. Discus what was left out (special needs, cultural lenses, etc.). Ask if anyone had anything to add based on their own experiences as educators.
b. This learning day will be referenced throughout the program and will provide the basis for the lesson plan development towards the end of the semester.
   Specifically, learning day #3 of the system and method of integrating environmental awareness into general classroom studies may include:

### Multicultural Environmental Education

### Learning Objectives:

be introduced to the concept of cultural lenses and the need for introspection to increase awareness

understand the concept of the dominant cannon in education, how it is perpetuated, and the levels of incorporation

examine 4 cultural lenses: race/ethnicity, social class, gender, and language

Materials: laptop/projector, PowerPoint handouts, Introspection Questions copies

III. Introduction: (8:30-11:00 am)

a. Welcome participants; pass out sign in sheet; review the agenda for the day

b. Review homework and discuss readings (Multicultural Education by James A. Banks); ask participants what they thought of the readings and how it relates to their personal experiences in education, either as a teacher or as a student. Explain that today we will delve into cultural lenses to better understand ourselves, our students, and our roles as environmental educators.

c. As with every class in the ATP, group input and discussion is not only valued, it is critical. Our experiences as individuals and as educators will help open others' eyes to new perspectives. Shared thoughts help support the group. If comfortable, please share experiences and thoughts during all classes.

d. Pass out handouts; use notes in the power point.

e. Have a few short 5-10 minute breaks throughout the PowerPoint.

f. Warn the participants that we will be viewing movie clips and some of them contain profanity. They may feel more comfortable leaving the room for these short portions.

IV. Conclusion: (11-11:30 am)

a. After the power point and activities, review with the participants and ask their opinions. Discuss what was left out and ask if anyone had anything to add based on their own experiences as educators.

b. This learning day will be referenced throughout the program and will provide the basis for the lesson plan development towards the end of the semester.

Specifically, learning day #4 of the system and method of integrating environmental awareness into general classroom studies may include:

### American Public Schools and EE

### Learning Objectives:

examine the roots and American public schools

discuss the many tasks the public schools have been assigned over time, from social equalizer to educating for national security

present on group topics: Teacher Unions, Native American Education in the West, Charter Schools, Standards and Testing, Special Education and Exceptionalities

discuss if, where, and how EE fits into the current state of public school education

Materials: laptop/projector, PowerPoint handouts, Historic IQ test copies

V. Introduction: (8:30-11:00 am)
a. Welcome participants; pass out sign in sheet; review the agenda for the day
b. Review homework and discuss process (research and present on various education topics); ask participants what they thought of the assignment and how it relates to their personal experiences in education, either as a teacher or as a student. Explain that today we will delve into the history of public schools in America to better understand ourselves, our students, and our roles as environmental educators.
c. As with every class in the ATP, group input and discussion is not only valued, it is critical. Our experiences as individuals and as educators will help open others' eyes to new perspectives. Shared thoughts help support the group. If comfortable, please share experiences and thoughts during all classes.
d. Pass out handouts; use notes in the power point.
e. Have a few short 5-10 minute breaks throughout the PowerPoint.
f. Even though EE works with all levels of community members, from birth to beyond, we must have an understanding of the public schooling in America since it affects everyone, even adults.

VI. Conclusion: (11-11:30 am)
a. After the power point and activities, review with the participants and ask their opinions. Discuss what was left out and ask if anyone had anything to add based on their own experiences as educators.
b. This learning day will be referenced throughout the program and will provide the basis for the lesson plan development towards the end of the semester.

Specifically, learning day #5 of the system and method of integrating environmental awareness into general classroom studies may include:

Lesson Plan Development: don't reinvent the wheel!

### Learning Objectives:

learn how to develop an EE lesson plan and incorporate the theory learning from prior sessions into this planning, from child development to cultural lenses

discuss how to adapt existing lesson plans and personalize them to fit any educational setting and teaching style so as not to reinvent the wheel

learn how to properly research and vet sources to ensure scientific credibility

Materials: laptop/projector, PowerPoint handouts, Project WET/Wild/Learning Tree books, Game and Fish lessons, Willow Bend lessons with kits and posters

VII. Prior to class: have lessons and kits open and out around the room for inspection activity later

VIII. Introduction: (8:30-10 am)
a. Welcome participants; pass out sign in sheet; review the agenda for the day
b. Review homework and discuss process (align an existing lesson plan with particular state science standards); ask participants what they thought of the assignment and how it relates to their personal experiences in education, either as a teacher or as a student. Explain that today we will use what we learned from the previous classes to learn how to make a functional EE lesson plan.
c. As with every class in the ATP, group input and discussion is not only valued, it is critical. Our experiences as individuals and as educators will help open others' eyes to new perspectives. Shared thoughts help support the group. If comfortable, please share experiences and thoughts during all classes.
d. Pass out handouts; use notes in the power point.
e. Have a few short 5-10 minute breaks throughout the PowerPoint.
f. Break: 10 minutes

IX. Lesson plan inspection and group activity: (10-11:30 am)
. Have participants walk around the room and walk through the kits on the tables. Have them examine the props and lessons keeping in mind everything we discussed.
b. After about 30 minutes, have participants break into groups and hand out randomly assigned topics and grade levels (see below). Have groups work together to create a simplified lesson plan, from theme to assessment.
   i. Water for 4^{th} grade, inner city, in a classroom
   ii. Astronomy for 12^{th} grade and up, outdoors at a county park
   iii. Bats for Kindergarten, reservation school, in a classroom
   iv. Sustainability for middle school, rural school, outdoors
   v. Agriculture for pre-K, English Language Learners, outdoors
   vi. Oceans for families with children of all ages, various socio-economic backgrounds, indoors at a nature center
c. After about 45 minutes, have two groups pair up and share their outlines.
d. Hand out the checklist for lesson plans and review as a group.

X. Conclusion: (11:30-12 noon)
a. After the power point and activities, review with the participants and ask their opinions. Discuss what was left out and ask if anyone had anything to add based on their own experiences as educators.
b. Discuss how the semester has built up to this one activity.

1. A method of training educators to develop environmentally aware lesson plans using a computer-implemented professional development system, wherein said method integrates awareness of environmental issues into general-studies teaching, wherein said system includes a computer having a data base including a plurality of environmental-specific instructional materials and materials relating to human behavior and development, said method comprising the steps of:
a. assembling one or more educators;
b. providing access to a computer device to each of said one or more educators;
c. providing a server connected to said computer device wherein said server includes a data base including foundational tools and information concerning culture's influence on environmental awareness;
d. in one or more training sessions and by accessing said data base, training said one or more educators about environmental awareness; and
e. instructing said one or more educators to develop at least one environmentally aware lesson plan utilizing said training.

2. The method in accordance with claim 1 where said one or more sessions include at least one of the steps of:
a. providing a foundation for the program by providing an understanding of culture's influence on environmental awareness;
b. providing an understanding of how humans develop and how that affects both learning and teaching of environmental education;
c. exploring human cultural lenses and their role in environmental education;
d. examining the history of education in America and how it has affected and will continue to affect environmental educations.

3. The method in accordance with claim 1 further including the step of providing a facilitator having access to a computer device wherein said facilitator has super-user privileges to the server and may access all aspects of the system.

4. The method in accordance with claim 1 further including the step of providing said one or more educators with at least one randomized classroom setting and at least one environmental topic for said one or more educators to develop said at least one environmentally aware lesson plan.

5. The method in accordance with claim 1 wherein said at least one environmentally aware lesson plan satisfies competency requirements of the North American Association for Environmental Education.

6. The method in accordance with claim 4 wherein said at least one environmentally aware lesson plan satisfies competency requirements of the North American Association for Environmental Education.

7. The method in accordance with claim 1 further including the step of providing a field-based study component to supplement said computer-implemented professional development system.

8. The method in accordance with claim 4 further including the step of providing a field-based study component to supplement said computer-implemented professional development system.

9. The method in accordance with claim 7 wherein said one or more training sessions last from about 12 hours to about 20 hours; said field-based study component lasts from about 2 hours to about 10 hours; and said development of said at least one environmentally aware lesson plan takes between about 8 hours to about 12 hours.

10. The method in accordance with claim 9 wherein said one or more training sessions last about 16 hours; said field-based study component lasts from about 4 hours; and said development of said at least one environmentally aware lesson plan takes about 10 hours.
